(19) United States
(12) Patent Application Publication
(10) Pub. No.: US 2021/0148622 A1
(43) Pub. Date: May 20, 2021

(54) ICE MAKER AFFIXED WITH OZONATED WATER AND HYPOCHLOROUS ACID WATER CAPABLE OF STERILIZING BACTERIA

(71) Applicant: Yantai United Ozonetec Corporation, Yantai (CN)

(72) Inventors: Ming-Yung Hsu, Yantai (CN); Wei-Chun Hsu, Yantai (CN)

(21) Appl. No.: 16/689,060

(22) Filed: Nov. 19, 2019

(51) Int. Cl. F25C 1/00; C02F 1/78; C02F 1/461

(52) U.S. Cl. CPC F25C 1/00; C02F 1/78; C02F 2001/46185; F25C 2400/12; C02F 1/4618

(57) ABSTRACT

An ice maker capable of sterilizing bacteria contains: a body, a compressor, a condenser, a cooling fan, and a control box. The condenser is connected with a capillarity tube on which a filtration program is installed, and the capillarity tube is connected with an expansion valve which communicates with an evaporator, and an ice cavity that has a heater. A tilted channel is located below the ice cavity, and a storage tank is fixed on the tilted channel. The body includes an ice water tank and a water pump communicating with multiple spray nozzles. The ice water tank includes a control valve connected with an intake, an overflow outlet is defined on the ice water tank, and a generator for ozonated and hypochlorous acid water is mounted in the ice water tank. The ozonated and hypochlorous acid water generator includes a casing, two inflow holes, two outflow holes, multiple cathode plates, and multiple anode plates.

### FIELD OF THE INVENTION

The present invention relates to an ice maker which produces ozonated and/or hypochlorous acid water to destroy bacteria.

### BACKGROUND OF THE INVENTION

Conventional ice makers contain an ice water tank in which running water is accommodated. However, the running water is contaminated by microorganism (such as bacteria, yeast, and fungus) easily. Furthermore, chlorine in the input water is filtered by a filtration device so that the running water flows into the ice water tank. At this point it is easy to breed bacteria and fungus, thus producing contaminated ice cubes.

To overcome above-mentioned defect, an improved ice maker is applied to by using ozone and/or hypochlorous acid to sterilize at this vulnerable point. Nevertheless, the improved ice maker obtains air ionization to produce ozone and hypochlorous acid in a high voltage discharging manner, thus producing nitrogen oxide.

CN Patent No. CN103436908A and CN Patent No. CN103436909A disclose an ice maker having an electrolytic ozone generator. Wherein when the electrolytic ozone generator operates to produce ozone gas mixed with running water so as to generate ozonated water to sterilize bacteria. Currently, these ice makers are complicated and are manufactured at high cost.

The present invention has arisen to mitigate and/or obviate the afore-described disadvantages.

### SUMMARY OF THE INVENTION

The primary aspect of the present invention is to provide an ice maker which produces ozonated and hypochlorous acid water to destroy bacteria.

To obtain above-mentioned aspect, an ice maker provided by the present invention contains: a body, a compressor accommodated in the body, a condenser, an inlet of which communicates with an outlet of the compressor, a cooling fan, and a control box.

The condenser has an outlet connected with a first end of a capillarity tube, a filtration program is installed on the capillarity tube, and a second end of the capillarity tube is connected with an expansion valve which communicates with an inlet of an evaporator via a first pipe. An outlet of the evaporator is in communication with an inlet of the compressor, and the evaporator is connected with an ice cavity on which a heater is mounted. A tilted channel is located below the ice cavity, and a storage tank is fixed on a bottom of the tilted channel. The body includes an ice water tank and a water pump which has an inlet connected with the ice water tank, and the water pump has an outlet communicating with multiple spray nozzles via a second pipe. The ice water tank includes an input water control valve accommodated therein and connected with an intake inlet, an overflow outlet which is mounted on a side of the ice water tank, a generator for ozonated and hypochlorous acid water which electrolyzes tap water (hereinafter referred to as the generator). It communicates with the control box via a wire. The control box is connected with the compressor, the heater, the water pump, the cooling fan, and a power cable via their own dedicated wires respectively. The control box is configured to control the ozonated and hypochlorous acid water generator, the compressor, the heater, the water pump, and the cooling fan. The generator includes a casing, inflow holes positioned on the lower portion of the casing, outflow holes formed on an upper portion of the casing, multiple cathode plates accommodated in the casing, and multiple anode plates received in the casing. Each of the anode plates is defined between any two adjacent cathode plates of the cathode plates, the multiple cathode plates are connected with a negative electrode of the control box via multiple cathode conductive studs respectively, and the multiple anode plates are connected with a positive electrode of the control box via multiple anode conductive studs each individually.

Preferably, the multiple anode plates are a coated titanium anode, and multiple cathode plates are a titanium cathode or a stainless steel cathode. The coated titanium anode has a tin dioxide coating layer consisting of titanium substrate, ruthenium, and nickel, wherein an atomic ratio of tin and ruthenium of the tin dioxide coating layer is 9:1, and an atomic ratio of ruthenium and nickel of the tin dioxide coating layer is 5:1.

Thereby, the ice maker is simplified and is manufactured at low fabrication cost. The ice maker has a generator to create ozonated and/or hypochlorous acid water configured to produce ozone and/or hypochlorous acid without harmful gas (such as nitrogen oxide). The generator is fixed in the ice water tank so as to produce ozone and/or hypochlorous acid micro-bubbles which dissolve and mix with the running water, thus producing ozonated and/or hypochlorous acid water. The ozonated and/or hypochlorous acid water disinfects the running water in the ice water tank and flows through the multiple spray nozzles and the ice cavity to destroy bacteria and to produce bacteria-free ice cubes. In addition, only small amount of ozone and hypochlorous acid spreads to air so that the ozone and hypochlorous acid surrounds the ice water tank to obtain bacteriostasis in the ice maker.

### BRIEF DESCRIPTION OF THE DRAWINGS

FIG. 1 is a schematic view showing the assembly of an ice maker capable of sterilizing bacteria according to a preferred embodiment of the present invention.

FIG. 2 is a schematic view showing the assembly of a generator for ozonated and hypochlorous acid water of the ice maker capable of sterilizing bacteria according to the preferred embodiment of the present invention.

### DETAILED DESCRIPTION OF THE PREFERRED EMBODIMENTS

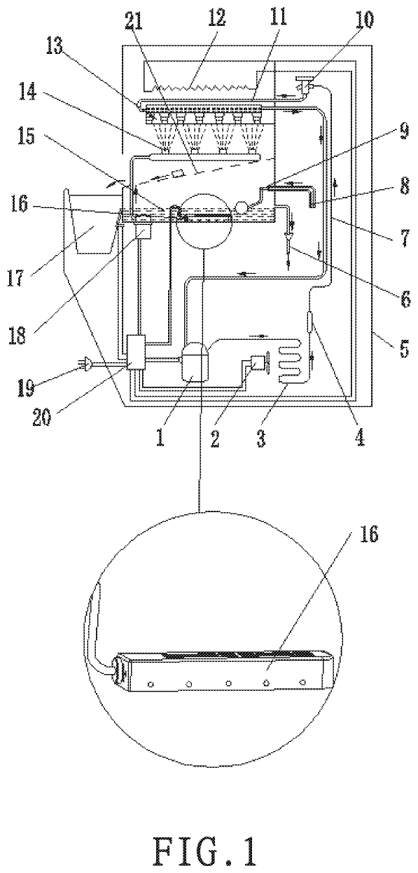

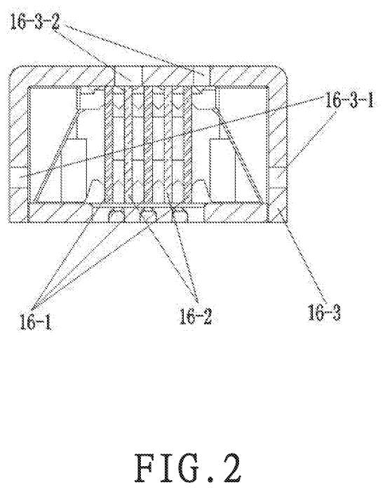

With reference to FIGS. 1 and 2, an ice maker capable of sterilizing bacteria according to the preferred embodiment of the present invention comprises: a body 5, a compressor 1 accommodated in the body 5, a condenser 3, an inlet of which communicates with an outlet of the compressor 1, a cooling fan 2, and a control box 20.

The condenser 3 has an outlet connected with a first end of a capillarity tube 7. A filtration program 4 is installed on the capillarity tube 7, and a second end of the capillarity tube 7 is connected with an expansion valve 10 which communicates with an inlet of an evaporator 11 via pipe. An outlet of the evaporator 11 is in communication with an inlet of the compressor 1, and the evaporator 11 is connected with an ice cavity 13 on which a heater 12 is mounted. A tilted channel 21 is located below the ice cavity 13, and a storage tank 17 is fixed on the bottom of the tilted channel 21.

The body 5 includes an ice water tank 15 and a water pump 18 which has an inlet connected with the ice water tank 15, and the water pump 18 has an outlet communicating with multiple spray nozzles 14 via a second pipe. The ice water tank 15 includes a control valve 9 accommodated therein and connected with an intake 8, an overflow outlet 6 defined on a side of the ice water tank 15, a generator for ozonated and hypochlorous acid water 16 mounted in the ice water tank 15, configured to electrolyte tap water, and communicating with the control box 20 via a dedicated wire. The control box 20 is connected with the compressor 1, the heater 12, the water pump 18, the cooling fan 2, and a power cable 19 via their own dedicated wires respectively. The control box 20 is configured to control the ozonated and hypochlorous acid water generator 16, the compressor 1, the heater 12, the water pump 18, and the cooling fan 2.

The generator 16 includes a casing 16-3, inflow holes 16-3-1 defined on a lower portion of the casing 16-3, outflow holes 16-3-2 formed on an upper portion of the casing 16-3, multiple cathode plates 16-1 accommodated in the casing 16-3, and multiple anode plates 16-2 in the casing 16-3, wherein each of the multiple anode plates 16-2 is defined between any two adjacent cathode plates 16-1 of the multiple cathode plates 16-1. The multiple cathode plates 16-1 are connected with a negative electrode of the control box 20 via multiple cathode conductive studs respectively, and the multiple anode plates 16-2 are connected with the positive electrode of the control box 20 via multiple anode conductive studs individually. The anode plates 16-2 are a coated titanium anode, and the cathode plates 16-1 are a titanium cathode or a stainless steel cathode. The coated titanium anode has a tin dioxide coating layer consisting of titanium substrate, ruthenium, and nickel, wherein an atomic ratio of tin and ruthenium of the tin dioxide coating layer is 9:1, and an atomic ratio of ruthenium and nickel of the tin dioxide coating layer is 5:1. After starting the ice maker, the running water is controlled by the control valve 9 to flow into the ice water tank 15 via the intake 8, and the control valve 9 turns off after the ice water tank 15 is filled with the running water. Thereafter, the running water flows into the ozone and hypochlorous acid water generator 16 via the two inflow holes 16-3-1 of the casing 16-3, wherein the control box 20 supplies a power having constant currents to the multiple cathode plates 16-1 and the multiple anode plates 16-2 of the ozone and hypochlorous acid water generator 16, and a voltage of the constant currents of the control box 20 is within 3.5 V to 16V. The running water is electrolyzed in an electric field so that oxygen ions produce ozone and hypochlorous acid micro-bubbles by using an anode catalyst, and the ozone and hypochlorous acid micro-bubbles dissolve and mix with the running water, thus producing ozonated and hypochlorous acid water. The ozonated and hypochlorous acid water flows through the two outflow holes 16-3-2 of the casing 16-3 to exchange with the running water of the ice water tank 15. The control box 20 actuates the compressor 1 to compress a low-temperature refrigerant so as to produce a high-temperature high-pressure refrigerant, and the high-temperature high-pressure is cooled by the condenser 3 to produce a normal-temperature liquid refrigerant in the running water, then the running water flows into the filtration program 4 so as to be filtered its moistures and impurities by the filtration program 4. Thereafter, the running water flows into the evaporator 11 via the capillarity tube 7 and the expansion valve 10 so as to be gasified and absorbed its heat, and the ice cavity 13 contacts with the evaporator 11 and is cooled to below a freezing point. In the meantime, the water pump 18 is started so that the ozonated and hypochlorous acid water flows to the ice cavity 13 from the ice water tank 15 via the multiple spray nozzles 14 so as to be frozen and to sterilize the ice cavity 13. The low-temperature refrigerant in the evaporator 11 flows into the compressor 1 via the tubes.

When a frozen layer reaches a predetermined thickness, the compressor 1 stops and the control box 20 supplies the power to the heater 12 so that sterile ice cubes remove from the ice cavity 13 and drop into the storage tank 17 via the tilted channel 21. Preferably, the control valve 9 is a float valve or is an electromagnetic valve controlled by a water level signal of the control box 20. In addition, only small amount of ozone and hypochlorous acid spreads to air so that the ozone and hypochlorous acid surrounds the ice water tank to obtain bacteriostasis in the ice maker.

The control box 20 is capable of supplying the power periodically and changing a value of the constant currents based on a water inflow and an ambient temperature so as to control ozone and hypochlorous acid quantity and to produce the ozonated and hypochlorous acid water, thus destroying bacteria in the ice maker.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An ice maker affixed with ozonated water and hypochlorous acid water capable of sterilizing bacteria comprising: a body (5), a compressor (1) accommodated in the body (5), a condenser (3), an inlet of which communicates with an outlet of the compressor (1), a cooling fan (2), and a control box (20);
herein the condenser (3) has an outlet connected with a first end of a capillarity tube (7), a filtration program (4) is installed on the capillarity tube (7), and a second end of the capillarity tube (7) is connected with an expansion valve (10) which communicates with an inlet of an evaporator (11) via a first pipe, an outlet of the evaporator (11) is in communication with an inlet of the compressor (1), and the evaporator (11) is connected with an ice cavity (13) on which a heater (12) is mounted, a tilted channel (21) is located below the ice cavity (13), and a storage tank (17) is fixed on a bottom of the tilted channel (21), the body (5) includes an ice water tank (15) and a water pump (18) which has an inlet connected with the ice water tank (15), and the water pump (18) has an outlet connected with multiple spray nozzles (14) via a second pipe, the ice water tank (15) includes a control valve (9) accommodated therein and connected with an intake (8), an overflow outlet (6) defined on a side of the ice water tank (15), a generator for ozonated and hypochlorous acid water (16) mounted in the ice water tank (15), configured to electrolyte tap water, and communicating with the control box (20) via a first wire, the control box (20) is connected with the compressor (1), the heater (12), the water pump (18), the cooling fan (2), and a power cable (19) via their own dedicated wires respectively. The control box (20) is configured to control the ozonated and hypochlorous acid water generator (16), the compressor (1), the heater (12), the water pump (18), and the cooling fan (2), the ozonated and hypochlorous acid water generator (16) includes a casing (16-3), inflow holes (16-3-1) defined on a lower portion of the casing (16-3), outflow holes (16-3-2) formed on an upper portion of the casing (16-3). Inside the case (16-3) there are cathode plates (16-1), and anode plates (16-2), wherein each of the anode plates (16-2) is positioned between any two adjacent cathode plates (16-1). The cathode plates (16-1) are connected with a negative electrode to the control box (20) each anode plate (16-2) is connected with a positive electrode to the control box (20) individually.

2. The ice maker affixed with ozonated water and hypochlorous acid water capable of sterilizing bacteria as claimed in claim 1, wherein the anode plates (16-2) are a coated titanium anode, and the cathode plates (16-1) are a titanium cathode or a stainless steel cathode, the coated titanium anode has a tin dioxide coating layer consisting of titanium substrate, ruthenium, and nickel, wherein an atomic ratio of tin and ruthenium of the tin dioxide coating layer is 9:1, and an atomic ratio of ruthenium and nickel of the tin dioxide coating layer is 5:1.
